(19) United States
(12) Patent Application Publication
(10) Pub. No.: US 2020/0133713 A1
(43) Pub. Date: Apr. 30, 2020

(54) Stack Overflow Processing Method and Apparatus

(71) Applicant: Alibaba Group Holding Limited, Grand Cayman (KY)

(72) Inventors: Zilong Liu, Hangzhou (CN); Liangliang Zhu, Hangzhou (CN); Xu Zeng, Hangzhou (CN); Lingjun Chen, Hangzhou (CN); Bin Wang, Hangzhou (CN); Junjie Cai, Hangzhou (CN)

(21) Appl. No.: 16/726,596

(22) Filed: Dec. 24, 2019

Related U.S. Application Data
(63) Continuation of application No. PCT/CN2018/092153, filed on Jun. 21, 2018.

(30) Foreign Application Priority Data
Jun. 27, 2017 (CN) 201710502695.7

(51) Int. Cl. G06F 9/48; G06F 13/16

(52) U.S. Cl. CPC G06F 9/4812; G06F 13/1668

(57) ABSTRACT

A method and an apparatus for stack overflow processing are provided. The method includes using a memory management device to detect whether any stack overflow occurs on a specified stack; and triggering a memory access interrupt by the memory management device when a stack overflow is detected on the specified stack. By using the memory management device to detect a stack overflow, the timeliness of stack overflow detection can be effectively improved, and occasional problems such as a stack overflow can be discovered timely, thus shortening the time of troubleshooting the problem of the stack overflow.

### CROSS REFERENCE TO RELATED PATENT APPLICATIONS

This application claims priority to and is a continuation of PCT Patent Application No. PCT/CN2018/092153 filed on 21 Jun. 2018, and is related to and claims priority to Chinese Patent Application No. 201710502695.7, filed on 27 Jun. 2017 and entitled “Stack Overflow Processing Method and Apparatus,” which are hereby incorporated by reference in their entirety.

### TECHNICAL FIELD

The present disclosure relates to the technical field of memory processing, and particularly to stack overflow processing methods and apparatuses.

### BACKGROUND

A stack overflow is an important cause that leads to instabilities of an operating system during operation of the operating system. Due to the occasional nature of stack overflow, it is often difficult to find a cause of the problem, thus leading to uncertainty in a development cycle of a product.

In existing technologies, stack overflow detection is usually performed as follows:

When a stack of a process is initialized, elements of the stack are initialized in turn using a specific magic number (such as 0x9527) according to a preset byte alignment. When a system is running, stacks of each process are sequentially traversed using a daemon process, and detection is performed as to whether a value of a stack element is equal to an initialized magic number. A ratio between the number of contaminated elements and a stack size is obtained, i.e., a usage amount of the stack. A determination of whether a stack overflow occurs based on the usage amount of the stack.

Through this method, although it is possible to detect whether a stack overflow occurs, it is necessary to determine whether an overflow occurs by detecting whether a magic number has changed when the system is running. At this time, the stack overflow has existed for some time. Therefore, the existing solution fails to detect the stack overflow in time, resulting in a longer time for troubleshooting the stack overflow.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of the above problems, embodiments of the present disclosure are proposed in order to provide a method for processing a stack overflow and a corresponding apparatus for processing a stack overflow that solve the above problems or at least partially solve the above problems.

In order to solve the above problems, the embodiments of the present disclosure disclose a method for processing a stack overflow. The method includes using a memory management device to detect whether any stack overflow occurs on a specified stack; and triggering a memory access interrupt by the memory management device when a stack overflow is detected on the specified stack.

In implementations, before using the memory management device to detect whether any stack overflow occurs in the specified stack, the method further includes obtaining stack information of the specified stack, the stack information including a start address and a stack size of the specified stack; determining an address of a stack bottom of the specified stack based on the start address of the specified stack and the stack size; and setting an access permission of the address of the stack bottom using the memory management device.

In implementations, the specified stack includes a task stack, and obtaining the stack information of the specified stack includes obtaining stack information of the task stack in response to detecting that the task stack performs task switching.

In implementations, the specified stack includes an interrupt stack, and obtaining the stack information of the specified stack includes obtaining stack information of the interrupt stack from a compiled link script program.

In implementations, using the memory management device to detect whether any stack overflow occurs on the specified stack includes determining that the specified stack has the stack overflow in response to detecting an access operation to the stack bottom.

In implementations, the method further includes obtaining context information corresponding to the stack overflow; and investigating a problem of the stack overflow based on the context information.

In implementations, the memory management device includes a memory protection unit (MPU) or a memory management unit (MMU).

The embodiments of the present disclosure further disclose an apparatus for processing a stack overflow. The apparatus includes a stack overflow detection module configured to detect whether any stack overflow occurs on a specified stack using a memory management device; and an interrupt processing module configured to trigger a memory access interrupt by the memory management device in response to detecting a stack overflow of the specified stack.

In implementations, the apparatus further includes a stack information acquisition module configured to obtain stack information of the specified stack, the stack information including a start address and a stack size of the specified stack; a stack bottom address determination module configured to determine an address of a stack bottom of the specified stack based on the starting address and the stack size of the specified stack; and an access permission setting module configured to set an access permission of the address of the stack bottom using the memory management device.

In implementations, the specified stack includes a task stack, and the stack information acquisition module is further configured to obtain stack information of the task stack in response to detecting the task stack performs task switching.

In implementations, the specified stack includes an interrupt stack, and the stack information acquisition module is further configured to obtain stack information of the interrupt stack from a compiled link script program.

In implementations, the stack overflow detection module is further configured to determine that the specified stack has the stack overflow in response to detecting an access operation to the bottom of the stack.

In implementations, the apparatus further includes a context information acquisition module configured to obtain context information corresponding to the stack overflow; and a troubleshooting module configured to investigate a problem of the stack overflow based on the context information.

In implementations, the memory management device includes a memory protection unit (MPU) or a memory management unit (MMU).

The embodiments of the present disclosure also disclose an apparatus, which includes one or more processors; and one or more machine-readable media having stored therein instructions that, when executed by the one or more processors, cause the apparatus to perform the methods described above.

The embodiments of the present disclosure also disclose one or more machine-readable media having stored thereon instructions that, when executed by one or more processors, cause an apparatus to perform the methods described above.

The embodiments of the present disclosure include the following advantages:

The embodiments of the present disclosure can detect whether an overflow occurs in a task stack or an interrupt stack using a memory management device. When the memory management device detects that an overflow occurs in the task stack or the interrupt stack, the memory management device immediately triggers a memory access interrupt. By using such hardware of the memory management device to detect a stack overflow, the timeliness of stack overflow detection can be improved effectively, and intermittent problems such as a stack overflow can be discovered timely, thus shortening the time of troubleshooting the problem of the stack overflow.

### BRIEF DESCRIPTION OF THE DRAWINGS

FIG. 1 is a flowchart showing a first exemplary method for processing a stack overflow according to the present disclosure.

FIG. 2 is a flowchart showing a second exemplary method for processing a stack overflow according to the present disclosure.

FIG. 3 is a structural block diagram of an exemplary apparatus for processing a stack overflow according to the present disclosure.

FIG. 4 is a structural block diagram of an exemplary smart terminal according to the present disclosure.

### DETAILED DESCRIPTION

In order to enable the foregoing purposes, features and advantages of the present disclosure to be more apparent and easily understood, the present disclosure is described in further detail in conjunction with the accompanying drawings and specific implementations.

The embodiments of the present disclosure may be applied in a computing device installed with an operating system. The computing device may include a terminal or a server, and the computing device may include a memory management device. Specifically, the memory management device can be configured to manage memory of the computing device, such as setting access permissions of the memory, detecting whether an overflow occurs in the memory, triggering an exception interruption of a memory access, and performing memory exception processing.

In implementations, the memory management device may include a hardware device and/or a software program.

For example, the memory management device may include an MPU (Memory Protection Unit). A domain in the MPU is values of some attributes and corresponding pieces of memory. These attributes include a start address, a length, read and write permissions, and cache, etc.

For another example, the memory management device may include an MMU (Memory Management Unit). The MMU is a control circuit configured to manage virtual memory and physical memory in a central processing unit (CPU), and is also responsible for mapping virtual addresses to physical addresses, and providing memory access authorization for hardware mechanisms, and multi-user multi-process operating system.

In implementations, such memory management may include management of a stack, wherein the stack is a first-in-last-out memory area that is abstracted from an operating system, and is mainly used for automatic accesses of local variables and interface call parameters. As an example, a stack can include a task stack and an interrupt stack.

The task stack can be used for storing context information when a task is switched.

The interrupt stack can be used for storing context information when an interrupt is generated.

The embodiments of the present disclosure can be applied to memory management in the Internet, and can also be applied to memory management in the Internet of Things (loT).

The memory management of the Internet of Things is used as an example hereinafter to describe the embodiments of the present disclosure in detail.

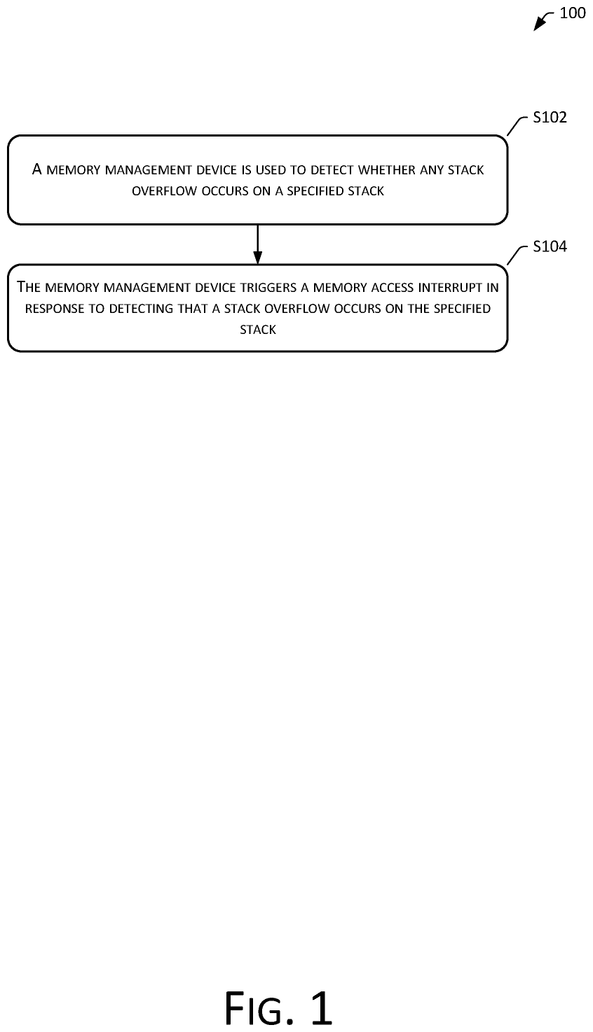

Referring to FIG. 1, a flowchart of a first exemplary method 100 for stack overflow processing in accordance with the present disclosure is shown. The method 100 may include the following operations.

S102: A memory management device is used to detect whether any stack overflow occurs on a specified stack.

In implementations, an operating system used by a computing device may include an RTOS (Real Time Operating System).

In implementations, the specified stack in implementations may include a task stack or an interrupt stack in the RTOS system.

S104: The memory management device triggers a memory access interrupt in response to detecting that a stack overflow occurs on the specified stack.

The embodiments of the present disclosure can detect whether an overflow occurs in a task stack or an interrupt stack using a memory management device. When the memory management device detects that an overflow occurs in the task stack or the interrupt stack, the memory management device immediately triggers a memory access interrupt. By using such hardware of the memory management device to detect a stack overflow, the timeliness of stack overflow detection can be effectively improved, and intermittent problems such as a stack overflow can be timely discovered, thus shortening the time of troubleshooting the problem of the stack overflow.

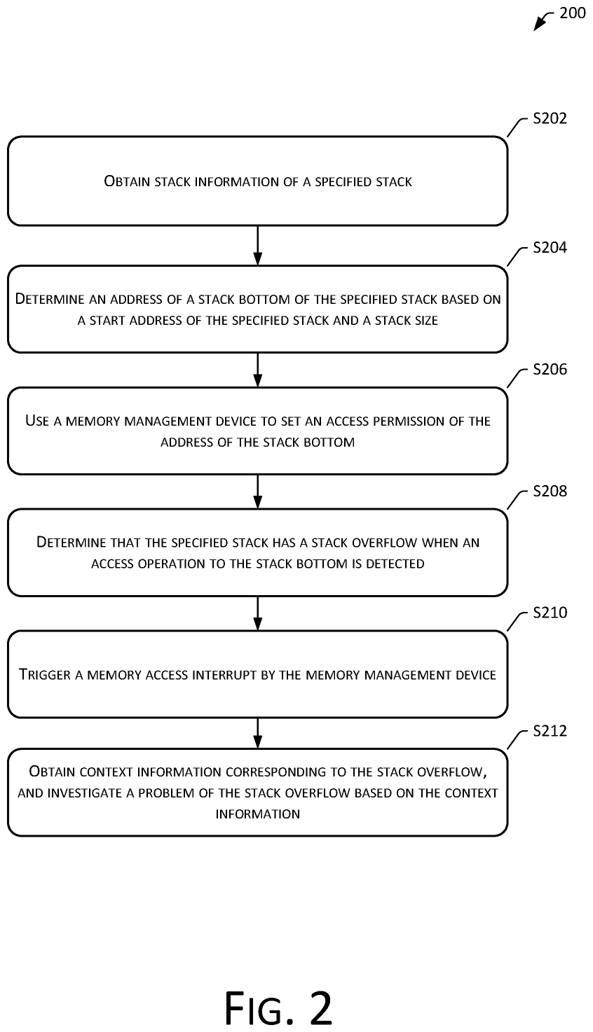

Referring to FIG. 2, a flowchart of a second exemplary method 200 for stack overflow processing of the present disclosure is shown. The method 200 may include the following operations.

S202: Obtain stack information of a specified stack.

In implementations, a RTOS system may obtain stack information of a specified stack. As an example, the stack information may include, but is not limited to, a start address, a stack size, a stack name, a task name, etc., of the specified stack.

In implementations, if the specified stack is a task stack, operation 201 may further include the following sub-operation: obtaining stack information of the task stack in response to detecting that the task stack performs task switching.

In implementations, since a task stack is switched as a task is switched, stack information of the task stack can be obtained in response to detecting the task stack is switched. In implementations, if detecting that a pointer of a task scheduled by a system is changed, a determination may be made that the task stack is switched at this time. At this time, a data structure of a switched task may be obtained according to an address pointed by a pointer of the switched task, and stack information is obtained from that data structure.

In implementations, if the specific stack is an interrupt stack, operation 201 may further include the following sub-operation: obtaining stack information of the interrupt stack from a compiled link script program.

In implementations, the IoT system shares an interrupt stack, and stack information is declared in a compiled link script of the system. Therefore, the stack information of the interrupt stack can be obtained from the compiled link script program before the system performs compiling.

S204: Determine an address of a stack bottom of the specified stack based on a start address of the specified stack and a stack size.

In implementations, the start address and the stack size of the corresponding stack may be obtained from the stack information, and the address of the stack bottom of the stack is obtained according to “start address of the stack+stack size”.

In practice, the address of the stack bottom can be a margin of the stack in a growing direction.

S206: Use a memory management device to set an access permission of the address of the stack bottom.

In implementations, after obtaining the address of the stack bottom, a memory management device may be used to set an access permission of the address of the stack bottom to protect the margin of the stack in the growing direction.

In implementations, a MPU protection may be set up for a memory space corresponding to the address of the stack bottom, and an access permission of the address of the stack bottom may be set in the MPU. As an example, the access permission may include: prohibiting reading and/or prohibiting writing and/or prohibiting executing codes, etc. Alternatively, the access permission may be set to prohibit all access operations.

S208: Determine that the specified stack has a stack overflow when an access operation to the stack bottom is detected.

In implementations, when an access operation for the address of the stack bottom is detected, a determination may be made that a stack overflow occurs in the task stack or the interrupt stack. In implementations, since the access permission of the stack bottom has been limited, when an operation such as reading or writing or executing is performed on the stack bottom, a stack overflow can be determined.

S210: Trigger a memory access interrupt by the memory management device.

In implementations, when an access operation for the stack bottom of the task stack or the interrupt stack is detected, an interruption associated with a memory access exception can be triggered immediately.

S212: Obtain context information corresponding to the stack overflow, and investigate a problem of the stack overflow based on the context information.

After the memory management device triggers a memory access interrupt, an operating system executes an interrupt exception handler for performing memory access exception handling.

During a process of memory access exception handling, context information can be printed and an anomaly analysis can be performed based on the context information for troubleshooting the problem.

In implementations, the context information may include, but is not limited to, a task identification that triggers the interrupt, an interrupt execution status, function call stack information, etc.

In implementations, the margin of the stack in the growth direction can be protected by the MPU, and operations such as reading and/or writing and/or execution are prohibited. A memory access interrupt is triggered immediately when a system code overflows. By using a method of a hardware interruption, the timeliness of stack overflow detection is effectively improved, and occasional problems such as stack overflows are timely discovered, thus shortening the time troubleshooting the stack overflows.

It should be noted that the method embodiments are all expressed as a series of action combinations for the sake of simple description. One skilled in the art should understand that the embodiments of the present disclosure are not limited by the described orders of actions, because certain operations may be performed in other orders or in parallel in accordance with embodiments of the present disclosure. Moreover, one skilled in the art should also understand that the embodiments described in the specification are all exemplary embodiments, and actions involved may not be necessarily needed by the embodiments of the present disclosure.

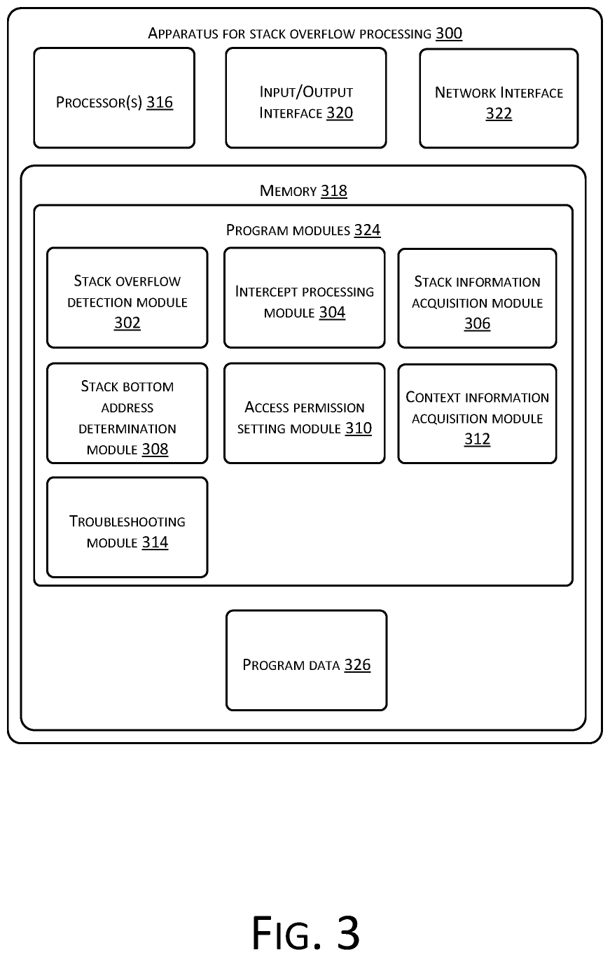

Referring to FIG. 3, a structural block diagram of an apparatus 300 for stack overflow processing of the present disclosure is shown. The apparatus 300 may include a stack overflow detection module 302 is configured to detect whether any stack overflow occurs on a specified stack using a memory management device; and an interrupt processing module 304 is configured to trigger a memory access interrupt using the memory management device in response to detecting a stack overflow of the specified stack.

In implementations, the apparatus 300 may further include a stack information acquisition module 306 configured to obtain stack information of the specified stack, the stack information including a start address and a stack size of the specified stack; a stack bottom address determination module 308 configured to determine an address of a stack bottom of the specified stack based on the starting address of the specified stack and the stack size; and an access permission setting module 310 configured to set an access permission of the address of the stack bottom using the memory management device.

In implementations, the specified stack includes a task stack, and the stack information acquisition module is further configured to obtain stack information of the task stack in response to detecting that task switching is performed for the task stack.

In implementations, the specified stack includes an interrupt stack, and the stack information acquisition module is further configured to obtain stack information of the interrupt stack from a compiled link script program.

In implementations, the stack overflow detection module 302 is further configured to determine that the specified stack has the stack overflow in response to detecting an access operation to the bottom of the stack.

In implementations, the apparatus 300 may further include a context information acquisition module 312 configured to obtain context information corresponding to the stack overflow; and a troubleshooting module 314 configured to investigate a problem of the stack overflow based on the context information.

In implementations, the memory management device includes a memory protection unit (MPU) or a memory management unit (MMU).

In implementations, the apparatus 300 may further include one or more processors 316, a memory 318, an input/output (I/O) interface 320, and a network interface 322.

The memory 318 may include a form of machine-readable media such as a volatile memory, a random access memory (RAM) and/or a non-volatile memory, for example, a read-only memory (ROM) or a flash RAM. The memory 318 is an example of a processor readable media.

The machine-readable media may include a volatile or non-volatile type, a removable or non-removable media, which may achieve storage of information using any method or technology. The information may include a machine-readable instruction, a data structure, a program module or other data. Examples of machine-readable media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the machine-readable media does not include transitory media, such as modulated data signals and carrier waves.

In implementations, the memory 318 may include program modules 324 and program data 326. The program modules 324 may include one or more modules as described in the foregoing description and shown in FIG. 3.

Due to their basic similarities to the method embodiments, the descriptions of the apparatus embodiments are relatively simple. Relevant parts can be found in the descriptions of the method embodiments.

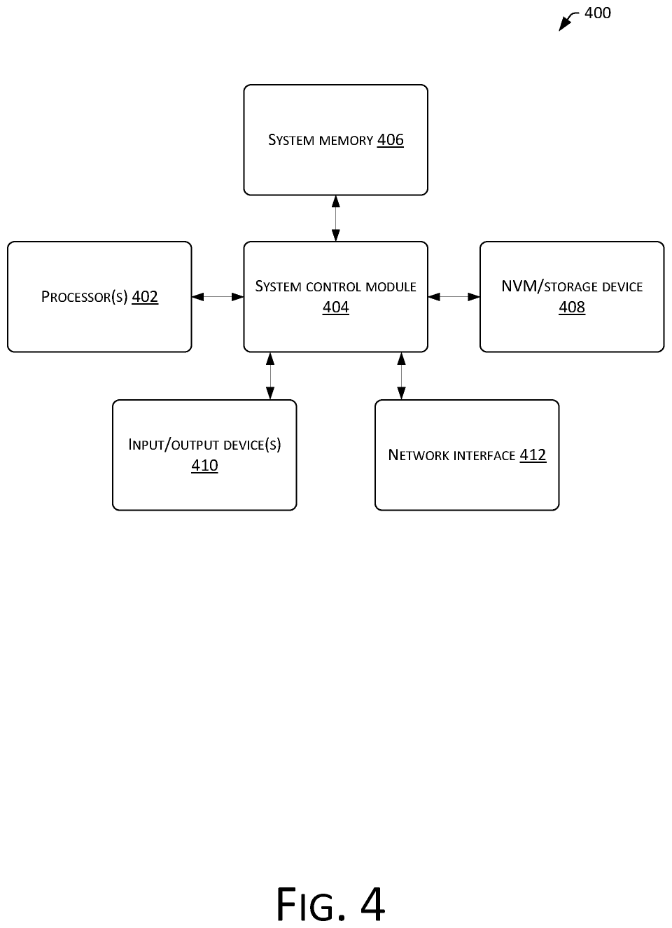

The embodiments of the present disclosure can be implemented as a system having a desired configuration using any suitable hardware, firmware, software, or any combination thereof. FIG. 4 schematically illustrates an exemplary system (or apparatus) 400 that can be utilized to implement various embodiments described in the present disclosure.

In implementations, FIG. 4 illustrates an exemplary system 400. The system includes one or more processors 402, a system control module (chipset) 404 coupled to at least one of the processor(s) 402, a system memory 406 coupled to the system control module 404, a non-volatile memory (NVM)/storage device 408 coupled to the system control module 404, and one or more input/output devices 410 coupled to the system control module 404, and a network interface 412 coupled to the system control module 406.

The processor 402 may include one or more single-core or multi-core processors. The processor 402 may include any combination of general-purpose or special-purpose processors (e.g., graphics processors, application processors, baseband processors, etc.).

In embodiments, the system 400 may include one or more computer readable media (e.g., the system memory 406 or the NVM/storage device 408) having instructions, and the one or more processors 402 that are in conjunction with the one or more computer readable media and configured to execute the instructions to implement modules for performing the actions described in the present disclosure.

In implementations, the system control module 404 may include any suitable interface controller to provide any suitable interface to at least one of the processor(s) 402 and/or any suitable device or component that communicates with the system control module 404.

The system control module 404 may include a memory controller module to provide an interface to the system memory 406. The memory controller module may be a hardware module, a software module, and/or a firmware module.

The system memory 406 may be used for loading and storing data and/or instructions for the system 400, for example. In implementations, the system memory 406 may include any suitable volatile memory, such as a suitable DRAM. In some embodiments, the system memory 406 may include double data rate fourth generation synchronous dynamic random access memory (DDR4 SDRAM).

In implementations, the system control module 404 may include one or more input/output controllers to provide an interface to the NVM/storage device 408 and the input/output device(s) 410.

For example, the NVM/storage device 408 may be configured to store data and/or instructions. The NVM/storage device 408 may include any suitable non-volatile memory (e.g., a flash memory) and/or may include any suitable non-volatile storage device(s) (e.g., one or more hard disk drives (HDD), one or more compact disc (CD) drives, and/or one or more digital versatile disc (DVD) drives).

The NVM/storage device 408 may include a storage resource that is a physical part of a device on which the system 400 is installed, or that may be accessed by the device without having to be a part of the device. For example, the NVM/storage device 408 may be accessed through a network via the input/output device(s) 410.

The NVM/storage device 408 may further include a memory management device. The memory management device may include an MPU or an MMU, etc., used for managing the memory of a terminal, such as setting access permissions of the memory, detecting whether an overflow occurs in the memory, triggering an interruption associated with a memory access exception, performing memory exception handling, etc.

The input/output device(s) 410 may provide an interface to the system 400 for communicating with any other suitable device. The input/output device 410 may include a communication component, an audio component, a sensor component, etc. The network interface 412 may provide an interface to the system 400 for conducting communications over one or more networks. The system 400 can conduct wireless communications with one or more components of a wireless network in accordance with any standard and/or protocol of one or more wireless network standards and/or protocols, for example, by accessing a wireless network based on a communication standard, such as WiFi, 2G or 3G, or a combination thereof for conducting wireless communications.

In implementations, at least one of the processor(s) 402 can be packaged with the logic of one or more controllers (e.g., the memory controller modules) of the system control module 404. In implementations, at least one of the processor(s) 402 can be packaged with the logic of one or more controllers of the system control module 404 to form a system in package (SiP). In implementations, at least one of the processor(s) 402 can be integrated with the logic of one or more controllers of the system control module 404 on the same mold. In implementations, at least one of the processor(s) 402 can be integrated with the logic of one or more controllers of the system control module 404 on the same mold to form a system on a chip (SoC).

In various embodiments, the system 400 may be, but is not limited to, a workstation, a desktop computing device, or a mobile computing device (e.g., a laptop computing device, a handheld computing device, a tablet, a netbook, etc.). In various embodiments, the system 400 may have more or fewer components and/or different architectures. For example, in some embodiments, the system 400 includes one or more cameras, a keyboard, a liquid crystal display (LCD) screen (including a touch screen display), a non-volatile memory port, multiple antennas, a graphics chip, an application specific integrated circuit (ASIC), and speakers.

If the display includes a touch panel, the screen of the display may be implemented as a touch screen display to receive an input signal from a user. The touch panel includes one or more touch sensors to sense touches, slides, and gestures on the touch panel. The touch sensor may sense not only the boundary of a touching or sliding action, but also the duration and pressure associated with a touching or sliding operation.

The embodiments of the present disclosure further provide a non-volatile readable storage medium. The storage medium stores one or more modules (programs), and the one or more modules, when being applied in a terminal device, can cause the terminal device to execute instructions of various method operations in implementations.

In an example, an apparatus is provided, and includes: one or more processors; and one or more machine-readable media storing instructions that, when executed by the one or more processors, cause the apparatus to perform the methods in implementations.

In an example, one or more machine-readable media is also provided, which stores instructions that, when executed by one or more processors, cause the apparatus to perform the methods in implementations.

Various embodiments in the present specification are described in a progressive manner, and each embodiment focuses on aspects that are different from those of other embodiments. Same and similar parts between various embodiments can be referenced to each other.

One skilled in the art should understand that an embodiment of the embodiments of the present disclosure can be provided as a method, an apparatus, or a computer program product. Therefore, the embodiments of the present disclosure may take a form of an entirely hardware embodiment, an entirely software embodiment, or an embodiment that is a combination of software and hardware. Moreover, the embodiments of the present disclosure can take a form of a computer program product embodied on one or more computer usable storage media (which include, but are not limited to, a magnetic disk storage device, a CD-ROM, an optical storage device, etc.) including computer usable program codes.

The embodiments of the present disclosure are described with reference to and according to flowcharts and/or block diagrams of exemplary methods, terminal devices (systems), and computer program products of the present disclosure. It should be understood that computer program instructions are used to implement each process and/or block of the flowcharts and/or the block diagrams, and combinations of processes and/or blocks of the flowcharts and/or the block diagrams. These computer program instructions can be provided to a processor of a general-purpose computer, a special-purpose computer, an embedded processor or other programmable data processing terminal device to produce a machine, to cause the instructions that are executed by the processor of the computer or the other programmable data processing terminal device to produce an apparatus for implementing the functions specified in one or more processes in the flowcharts or one or more blocks of the block diagrams.

The computer program instructions can also be stored in a computer readable storage device that can direct a computer or other programmable data processing terminal device to operate in a particular manner, such that the instructions stored in the computer readable storage device produce an article of manufacture including an instruction apparatus. The instruction apparatus implements the functions specified in one or more processes of the flowcharts and/or one or more blocks of the block diagrams.

These computer program instructions can also be loaded onto a computer or other programmable data processing terminal device, such that a series of operational operations are executed by the computer or the other programmable terminal device to produce computer-implemented processing, thereby the instructions executed by the computer or the other programmable terminal device providing operations for implementing the functions specified in one or more processes of the flowcharts and/or one or more blocks of the block diagrams.

Although exemplary embodiments of the embodiments of the present disclosure have been described, one skilled in the art can make further changes and modifications to the embodiments once being aware of the basic inventive concepts. Therefore, the appended claims are intended to be interpreted as including all changes and modifications that fall within the scope of the embodiments of the present disclosure.

Finally, it should also be noted that relational terms such as first and second in this context are used merely to distinguish one entity or operation from another entity or operation, and do not necessarily require or imply any type of actual relationship or order between these entities or operations. Furthermore, terms “containing”, “including”, or any other variations are intended to encompass a non-exclusive inclusion, such that a process, method, article, or terminal device that includes a series of elements not only includes these elements, but also includes other elements that are explicitly listed, or includes elements that are inherent to such process, method, article, or terminal device. Without any additional limitations, an element defined by a phrase “including a . . . ” does not exclude the presence of additional identical elements in the process, method, article, or terminal device that includes the element.

The methods and apparatuses for stack overflow processing provided by the present disclosure are described in detail above. The principles and implementations of the present disclosure are described using the specific examples. The above description of the embodiments is merely used for helping the understanding of the methods of the present disclosure and core ideas thereof. Furthermore, for one skilled in the art, changes exist in the specific implementations and application scopes according to the ideas of the present disclosure. In summary, the content of this specification should not be construed as limitations to the present disclosure.

The present disclosure may further be understood using the following clauses.

Clause 1: A method for stack overflow processing, the method comprising: using a memory management device to detect whether any stack overflow occurs on a specified stack; and triggering a memory access interrupt by the memory management device when a stack overflow is detected on the specified stack.

Clause 2: The method of Clause 1, wherein before using the memory management device to detect whether any stack overflow occurs in the specified stack, the method further comprises: obtaining stack information of the specified stack, the stack information including a start address and a stack size of the specified stack; determining an address of a stack bottom of the specified stack based on the start address of the specified stack and the stack size; and setting an access permission of the address of the stack bottom using the memory management device.

Clause 3: The method of Clause 2, wherein the specified stack comprises a task stack, and obtaining the stack information of the specified stack comprises obtaining stack information of the task stack in response to detecting that the task stack performs task switching.

Clause 4: The method of Clause 2, wherein the specified stack comprises an interrupt stack, and obtaining the stack information of the specified stack comprises obtaining stack information of the interrupt stack from a compiled link script program.

Clause 5: The method of any one of Clauses 2-4, wherein using the memory management device to detect whether any stack overflow occurs on the specified stack comprises determining that the specified stack has the stack overflow in response to detecting an access operation to the stack bottom.

Clause 6: The method of any one of Clauses 1-4, further comprising obtaining context information corresponding to the stack overflow; and investigating a problem of the stack overflow based on the context information.

Clause 7: The method of Clause 1, wherein the memory management device comprises a memory protection unit (MPU) or a memory management unit (MMU).

Clause 8: An apparatus for processing a stack overflow, the apparatus comprising: a stack overflow detection module configured to detect whether any stack overflow occurs on a specified stack using a memory management device; and an interrupt processing module configured to trigger a memory access interrupt by the memory management device in response to detecting a stack overflow of the specified stack.

Clause 9: The apparatus of Clause 8, further comprising: a stack information acquisition module configured to obtain stack information of the specified stack, the stack information including a start address and a stack size of the specified stack; a stack bottom address determination module configured to determine an address of a stack bottom of the specified stack based on the starting address and the stack size of the specified stack; and an access permission setting module configured to set an access permission of the address of the stack bottom using the memory management device.

Clause 10: The apparatus of Clause 9, wherein the specified stack comprises a task stack, and the stack information acquisition module is further configured to obtain stack information of the task stack in response to detecting the task stack performs task switching.

Clause 11: The apparatus of Clause 9, wherein the specified stack comprises an interrupt stack, and the stack information acquisition module is further configured to obtain stack information of the interrupt stack from a compiled link script program.

Clause 12: The apparatus of any one of Clauses 9-11, wherein the stack overflow detection module is further configured to determine that the specified stack has the stack overflow in response to detecting an access operation to the bottom of the stack.

Clause 13: The apparatus of any one of Clauses 8-11, further comprising: a context information acquisition module configured to obtain context information corresponding to the stack overflow; and a troubleshooting module configured to investigate a problem of the stack overflow based on the context information.

Clause 14: The apparatus of Clause 8, wherein the memory management device comprises a memory protection unit (MPU) or a memory management unit (MMU).

Clause 15: An apparatus comprising: one or more processors; and one or more machine-readable media having stored therein instructions that, when executed by the one or more processors, cause the apparatus to perform one or more methods of Clauses 1-7.

Clause 16: One or more machine-readable media storing instructions that, when executed by one or more processors, cause an apparatus to perform one or more methods of Clauses 1-7.

What is claimed is:

1. A method implemented by one or more processors of a computing device, the method comprising:
using a memory management device to detect whether any stack overflow occurs on a specified stack; and
triggering a memory access interrupt by the memory management device when a stack overflow is detected on the specified stack.

2. The method of claim 1, wherein before using the memory management device to detect whether any stack overflow occurs in the specified stack, the method further comprises:
obtaining stack information of the specified stack, the stack information including a start address and a stack size of the specified stack;
determining an address of a stack bottom of the specified stack based on the start address of the specified stack and the stack size; and
setting an access permission of the address of the stack bottom using the memory management device.

3. The method of claim 2, wherein the specified stack comprises a task stack, and obtaining the stack information of the specified stack comprises:
obtaining stack information of the task stack in response to detecting that the task stack performs task switching.

4. The method of claim 2, wherein the specified stack comprises an interrupt stack, and obtaining the stack information of the specified stack comprises obtaining stack information of the interrupt stack from a compiled link script program.

5. The method of claim 2, wherein using the memory management device to detect whether any stack overflow occurs on the specified stack comprises determining that the specified stack has the stack overflow in response to detecting an access operation to the stack bottom.

6. The method of claim 1, further comprising obtaining context information corresponding to the stack overflow; and investigating a problem of the stack overflow based on the context information.

7. The method of claim 1, wherein the memory management device comprises a memory protection unit (MPU) or a memory management unit (MMU).

8. An apparatus comprising:
one or more processors;
memory;
a stack overflow detection module stored in the memory and executable by the one or more processors to detect whether any stack overflow occurs on a specified stack using a memory management device; and
an interrupt processing module stored in the memory and executable by the one or more processors to trigger a memory access interrupt by the memory management device in response to detecting a stack overflow of the specified stack.

9. The apparatus of claim 8, further comprising:
a stack information acquisition module configured to obtain stack information of the specified stack, the stack information including a start address and a stack size of the specified stack;
a stack bottom address determination module configured to determine an address of a stack bottom of the specified stack based on the starting address and the stack size of the specified stack; and
an access permission setting module configured to set an access permission of the address of the stack bottom using the memory management device.

10. The apparatus of claim 9, wherein the specified stack comprises a task stack, and the stack information acquisition module is further configured to obtain stack information of the task stack in response to detecting the task stack performs task switching.

11. The apparatus of claim 9, wherein the specified stack comprises an interrupt stack, and the stack information acquisition module is further configured to obtain stack information of the interrupt stack from a compiled link script program.

12. The apparatus of claim 9, wherein the stack overflow detection module is further configured to determine that the specified stack has the stack overflow in response to detecting an access operation to the bottom of the stack.

13. The apparatus of claim 8, further comprising:
a context information acquisition module configured to obtain context information corresponding to the stack overflow; and
a troubleshooting module configured to investigate a problem of the stack overflow based on the context information.

14. The apparatus of claim 8, wherein the memory management device comprises a memory protection unit (MPU) or a memory management unit (MMU).

15. One or more machine-readable media storing instructions that, when executed by one or more processors, cause the one or more processors to perform acts comprising:
using a memory management device to detect whether any stack overflow occurs on a specified stack; and
triggering a memory access interrupt by the memory management device when a stack overflow is detected on the specified stack.

16. The one or more machine-readable media of claim 15, wherein before using the memory management device to detect whether any stack overflow occurs in the specified stack, the acts further comprise:
obtaining stack information of the specified stack, the stack information including a start address and a stack size of the specified stack;
determining an address of a stack bottom of the specified stack based on the start address of the specified stack and the stack size; and
setting an access permission of the address of the stack bottom using the memory management device.

17. The one or more machine-readable media of claim 16, wherein the specified stack comprises a task stack, and obtaining the stack information of the specified stack comprises:
obtaining stack information of the task stack in response to detecting that the task stack performs task switching.

18. The one or more machine-readable media of claim 16, wherein the specified stack comprises an interrupt stack, and obtaining the stack information of the specified stack comprises obtaining stack information of the interrupt stack from a compiled link script program.

19. The one or more machine-readable media of claim 16, wherein using the memory management device to detect whether any stack overflow occurs on the specified stack comprises determining that the specified stack has the stack overflow in response to detecting an access operation to the stack bottom.

20. The one or more machine-readable media of claim 15, the acts further comprising obtaining context information corresponding to the stack overflow; and investigating a problem of the stack overflow based on the context information.
